(19) United States
(12) Patent Application Publication
(10) Pub. No.: US 2024/0424982 A1
(43) Pub. Date: Dec. 26, 2024

(54) Electronic License Plate for a Motor Vehicle, Method, Computer-Readable Medium, and Motor Vehicle for Same

(71) Applicant: Bayerische Motoren Werke Aktiengesellschaft, Muenchen (DE)

(72) Inventors: Martin Ortner, Munchen (DE); Manuel Schlienz, Althegnenberg (DE)

(21) Appl. No.: 18/749,346

(22) Filed: Jun. 20, 2024

(30) Foreign Application Priority Data
Jun. 22, 2023 (DE) 10 2023 116 433.3

(51) Int. Cl. B60Q 1/56; B60R 13/10; B60R 25/24; H04W 12/0433; H04W 76/20

(52) U.S. Cl. CPC B60Q 1/56; B60R 13/10; H04W 12/0433; H04W 76/20; B60R 25/24

(57) ABSTRACT

An electronic license plate for a motor vehicle that has an active connection to a terminal of a user of the motor vehicle. The license plate includes an output for outputting license plate information, a communication interface configured for wireless communication and a data processing device for operating the license plate. The communication interface receives identification information from the terminal. The data processing device determines the license plate information based on the identification information and operates the output to output the license plate information.

This application claims priority to German Patent Application No. 10 2023 116 433.3 filed on Jun. 22, 2023, the disclosure of which is incorporated in its entirety by reference herein.

### TECHNICAL FIELD

The present disclosure relates generally to electronic license plates for a motor vehicle, wherein the motor vehicle has an active connection to a terminal of a user of the motor vehicle.

### BACKGROUND

Motor vehicle license plates or number plates are known from the prior art. Such a license plate may be an embossed and/or printed vehicle registration number.

In addition, electronic license plates and electronic vehicle registration plates are known from the prior art. Such electronic license plates may have an output device for outputting a license plate as license plate information. In addition, such license plates may have a communication interface, for example for transmitting information about the location of the motor vehicle and/or payment information. It is also possible to adapt the design of the output.

US 2002/021210 A1 discloses an electronic license plate with a housing with a generally rectangular configuration. The housing can be mounted on the license plate bracket of the vehicle and is powered by a vehicle power system. The housing has a front panel with a digital display. The digital display shows relevant license plate information of the vehicle. The information refers to a license plate, an issue status, and an expiration date. The housing contains a memory chip for storing the relevant license plate information. The memory chip is connected to a main computer system of a selected authority. Mechanisms for deactivating the license plate are connected to the memory chip, whereby removing the housing from the vehicle deactivates the memory chip and prevents the future use of the electronic license plate. In addition, removing the license plate will put the vehicle out of service. Special status indicator mechanisms are connected to the main computer system and the memory chip, so that a theft message entered into the main computer system indicates such a status on the digital display.

US 2019/0381957 A1 discloses an electronic license plate with a digital display covered with a protective layer of glass, positioned in a display frame, and electronically connected to a motherboard. A wireless communication device allows the content of the digital display to be controlled over cellular networks or other wireless means of communication. A method of using the electronic license plate allows for the display and updating of relevant license plate information, as well as GPS tracking, toll and parking fee payment functions.

DE 20 2010 006 825 U1 discloses a license plate for a motor vehicle, wherein the license plate has at least one electronic means of displaying a single or multi-line combination of letters and/or numbers of a vehicle registration number and also contains at least one display control unit or is connected or can be connected to it, wherein the display of the font and the layout on the display means corresponds to that of a country-specific motor vehicle license plate. The display control unit can be housed in the vehicle electronics.

Electronic license plates, especially from different manufacturers, can have different characteristics, technologies and security standards.

A license plate number may be linked to the identity of a person in whose name a motor vehicle is registered and/or licensed and/or by whom the motor vehicle is operated. For example, a license plate number may be associated with a social security number. This means that a manufacturer and/or provider of an electronic license plate must have access to the social security number and/or other personal data of a potential car owner. For this, each manufacturer and/or provider can have its own concept, which can have security gaps.

Against the background of this prior art, one of the objects of the present disclosure is to provide an electronic license plate which improves at least the aforementioned aspects of the prior art. In particular, it is the object of the disclosure to achieve a reliable and effective link between a license plate number and personal information.

### SUMMARY

The object is achieved by the characteristics of the independent claims. The dependent claims relate to developments of the disclosure.

Accordingly, the object is achieved according to one aspect of the disclosure by an electronic license plate for a motor vehicle, wherein the motor vehicle has an active connection to a terminal of a user of the motor vehicle. The license plate has: an output device for the output of license plate information; a communication interface set up for wireless communication; a data processing device for operating the license plate; wherein the communication interface is set up to receive identification information from the terminal; and the data processing device is set up to determine the license plate information on the basis of the identification information and to operate the output device to output the license plate information.

It was recognized that personal data that can identify the user may be stored on a user's device. The terminal may therefore contain the identifying information that identifies the terminal and/or the user. The terminal can transmit the identification information to the electronic license plate. The electronic license plate can receive the identification information through the communication interface and process it through the data processing device. Here the motor vehicle may have an active connection to the terminal in that the electric license plate of the motor vehicle receives the identification information from the terminal. The identification information can be used to determine the license plate information. The license plate information includes, for example, an alphanumeric sequence of letters and/or numbers as the license plate number and can be displayed by the output device in order to provide the motor vehicle with a license plate.

This makes it possible for the identification information of the terminal to be used to reliably identify the terminal or the user of the terminal. This means that a correct license plate can be displayed reliably. Communication between the electronic license plate and a manufacturer and/or service provider of the electronic license plate may be unnecessary. This can reduce security risks.

Optionally, the identification information has a key associated with the terminal and/or the user of the terminal and the data processing device is set up to match the key. It was recognized that a digital key can further improve the security and reliability of the identification of the user. Such a digital key can be issued, for example, by a certification authority that has confidential access to the user's personal data and/or the user's social security number. For example, the digital key can be a public key and a private key can be stored in a data memory of the data processing device of the electronic license plate. The pair of keys can be used for matching to reliably establish the identity of the user.

Optionally, the data processing device is set up to process a plurality of identifying information that can be assigned to different terminals and/or users. This makes it possible for the electronic license plate to receive various identification information items via the communication interface and to process them through the data processing device in order to identify various users and/or terminals. This makes it possible for the motor vehicle with the electronic license plate to be made accessible to multiple users. This may apply, for example, in the event of a change of motor vehicle by the user and/or a change of a user of the motor vehicle, for example in the case of rental vehicles and/or car sharing.

Optionally, the communication interface is set up for communication with a server outside the vehicle and to receive reconciliation information. This makes it possible for the electronic license plate to verify the identification information in real time.

Optionally, the communication interface is set up for communication with a vehicle control unit and to issue a lock and/or unlock signal to lock or unlock a vehicle function. This makes it possible for access to the motor vehicle to be controlled on the basis of the identification information. When access to the motor vehicle is granted, the unlock signal can be issued to unlock and/or operate the motor vehicle and appropriate license plate information can be issued. Otherwise, if access to the motor vehicle is denied, there may be no need to issue the unlock signal and/or the locking signal may be issued.

In other words, and in relation to a specific embodiment which is described as not limiting the present disclosure, the above can be summarized as follows: the disclosure relates to a digital key for digital license plates. Digital license plates are known from the prior art. Different manufacturers can offer such license plates with different technologies and security standards. Each manufacturer of an electric license plate can follow its own concept, which can have security gaps. Such a license plate may be linked to sensitive personal information such as the social security number. Therefore, in order to operate the license plate, the user must, for example, entrust the social security number to the license plate manufacturer. The core idea of the disclosure is the linking of a valid digital key on a terminal (“smart device”) to the respective personal data, such as the user's social security number, which is necessary for the operation of the license plate or motor vehicle. Furthermore, it is envisaged to integrate the display of the digital license plate into the outer skin of the vehicle and/or to use the vehicle infrastructure, such as BUS systems, security standard, power supply and/or mobile phone connection, to control the electronic license plate.

According to one aspect of the disclosure, a method is provided for operating an electronic license plate for a motor vehicle, wherein the motor vehicle has an active connection to a terminal of a user of the motor vehicle, wherein the method includes: receiving identification information from the terminal; determining license plate information from the identification information; and outputting license plate information by means of an output device of the license plate. The method can be carried out in such a way that one or more of the features described as optional in relation to the electronic license plate are implemented in order to achieve a related technical effect.

According to an aspect of the disclosure, a computer program and/or computer-readable medium is/are provided. The computer program and/or the computer-readable medium contain(s) commands which, when executed by a computer, cause it to carry out the method in accordance with the disclosure and/or steps thereof.

According to an aspect of the disclosure, a motor vehicle, containing the electronic license plate described above, is provided. Optionally, the electronic license plate may have one or more of the optional features described above in order to achieve an associated technical effect.

Optionally, the vehicle has an outer skin and an on-board electrical system, and the electronic license plate is integrated into the outer skin and/or can be operated via the on-board electrical system. It was recognized that by integrating the electronic license plate into the outer skin, a physical integration of the electronic license plate into the motor vehicle can be achieved. Alternatively or additionally, the electronic license plate can be operated through the on-board electrical system of the motor vehicle in order to functionally integrate the electronic license plate into the motor vehicle. The on-board electrical system can integrate the electronic license plate with regard to the supply of electrical energy and/or to the communication of information.

The above-described features and advantages, as well as others, will become more readily apparent to those of ordinary skill in the art by reference to the following detailed description and accompanying drawings.

### BRIEF DESCRIPTION OF THE DRAWINGS

FIG. 1 schematically shows an electronic license plate and a motor vehicle according to an aspect of the disclosure; and

FIG. 2 schematically shows a flow chart of a method according to an aspect of the disclosure.

### DETAILED DESCRIPTION

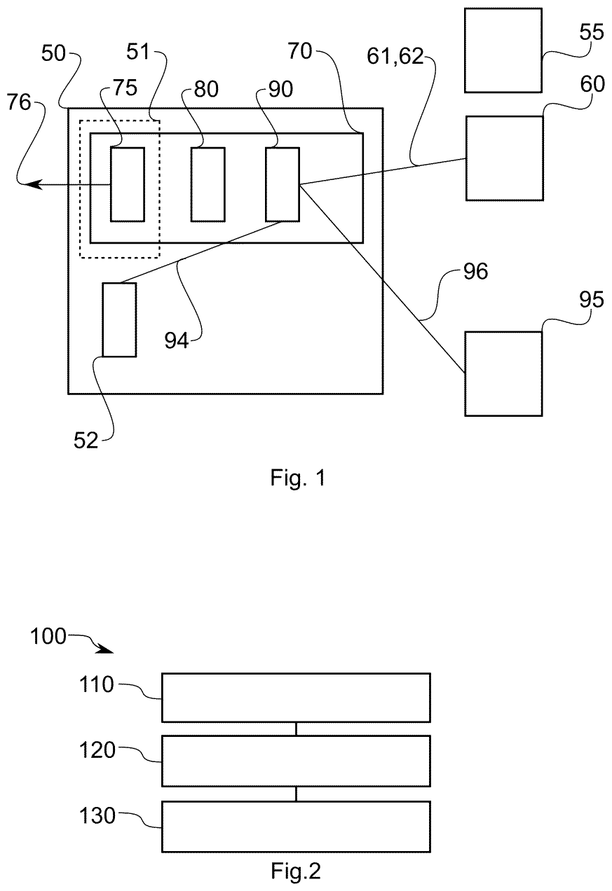

FIG. 1 schematically shows an electronic license plate 70 and a motor vehicle 50, each according to an aspect of the disclosure. In addition, FIG. 1 shows a user 55, a terminal 60 and an external server 95.

The user 55 is a user of the terminal 60 and, for example, the owner of the terminal 60. The terminal 60 is, for example, a smartphone, a wearable, a tablet, a portable computer and/or a key for opening, closing and/or operating the motor vehicle 50.

The user 55 has arranged for an identification information 61 and a key 62 to be stored on the terminal 60 in an electronic data storage device (not shown) of the terminal 60. The identification information 61 includes personal data that can identify the user 55 and the key 62 is associated with the identification information 61, the terminal 60 and/or the user 55 of the terminal 60.

The identification number 61 is entered by the user 55 and/or issued by a third-party certification authority. The key 62 is a piece of information associated with the user 55 and/or the identification information 61 that is used to verify and/or establish the non-repudiation of identification information 61. The key 62 can be a key from a pair of keys.

The user 55 is also a potential user or owner, renter and/or driver of the motor vehicle 50.

For example, the motor vehicle 50 is registered and/or licensed for operation in road traffic. For this purpose, the motor vehicle 50 contains an electronic license plate 70. The electronic license plate 70 is set up to carry out the method 100 described in FIG. 2. To that end, the electronic license plate 70 as shown in FIG. 1 has an output device 75, a communication interface 80 and a data processing device 90.

The output device 75 is set up to output license plate information 76. For this purpose, the output device 75 contains a display based on electronic paper, on an LCD display and/or on an OLED display. The output device 75 contains a pixel matrix and/or a segment display. The output device 75 can be controlled by the data processing device 90 in order to display the license plate information 76 in a visually perceptible way. The license plate information 76 contains an alphanumeric sequence of characters, symbols, pictograms and/or images.

The communication interface 80 is set up for wireless communication. The communication interface 80 is set up to receive identification information 61 from the terminal 60. For this purpose, the communication interface 80 is set up for communication via Bluetooth and/or ultra-wideband technology (UWB), for example, and can be connected to the terminal 60 for data transmission.

The communication interface 80 is set up for communication with an external server 95 and to receive reconciliation information 96. The external server 95 is a server or cloud provided and/or operated by the vehicle manufacturer. To communicate between the license plate 70 and the server 95, the communication interface 80 is set up for communication via a wireless local area network (WLAN) and/or a mobile network. Using the communication interface 80, the electronic license plate 70 can submit a request to the server 95 for verification of the identification information 61 and/or a key 62. As a result of checking the identification information 61 and/or the key 62, the server creates the matching information 96 and transmits the matching information 96 to the communication interface 80.

Alternatively or additionally, the electronic license plate 70 is set up to access an on-board communication interface (not shown) in order to communicate with the terminal 60 and/or the server 95. For example, the on-board communication interface is set up for communication with the external server 95 and/or the terminal 60. For this purpose, the communication interfaces are set up for communication via a wireless local area network (WLAN), a mobile network, Bluetooth and/or UWB.

The communication interface 80 is set up for communication with a motor vehicle control unit 53 and to issue a lock and/or unlock signal 54 to lock or unlock a vehicle function. For example, the vehicle function is a function for opening and/or operating the vehicle. If the user 55 is allowed access to the motor vehicle 50, the motor vehicle 50 can be unlocked. Otherwise, if the user 55 is denied access to the motor vehicle 50, the motor vehicle 50 may be locked and/or remain locked.

The data processing device 90 is set up to operate the license plate 70. The data processing device 90 is set up to determine the license plate information 76 on the basis of the identification information 61 and to operate the output device 75 to output the license plate information 76. For this purpose, the data processing device 90 is set up for matching the key 62, optionally taking into account the matching information 96. The data processing device 90 is set up to process a plurality of identification information items 61 that can be associated with different terminals 60 and/or users 55.

The motor vehicle 50 has an outer skin 51. The outer skin 51 includes, for example, components of a body of the motor vehicle 50 and/or components of windows, doors and/or flaps of the motor vehicle 50.

The electronic license plate 70 is integrated into the outer skin 51. In another embodiment (not shown), the electronic license plate 70 is a separate component from the motor vehicle 50 or the outer skin 51 and can be mounted on the outer skin 51 of the motor vehicle 50.

The motor vehicle 50 according to FIG. 1 has an on-board electrical system 52. The on-board electrical system 52 contains a fieldbus or a BUS system and/or a CAN bus and/or an electrical power supply. For example, the electronic license plate 70 can be connected to the communication interface of the vehicle via the on-board electrical system 52. The electronic license plate 70 can be operated via the on-board electrical system 52. The electronic license plate 70 can be supplied with electrical energy via the on-board electrical system 52.

The motor vehicle 50 has an active connection to the user's 55 terminal 60. The active connection may exist solely due to the intention of the user 55 and/or potential user 55 to use the motor vehicle 50, wherein the identification information 61 is transmitted from the terminal 60 to the electronic license plate 70 of the motor vehicle 50.

FIG. 2 shows schematically a flow chart of a method 100 according to an aspect of the disclosure. The method 100 according to FIG. 2 is a method 100 for the operation of an electronic license plate 70 for a motor vehicle 50, wherein the motor vehicle 50 has an active connection to a terminal 60 of a user 55 of the motor vehicle 50. Such a motor vehicle 50 is described with reference to FIG. 1. FIG. 2 is described with reference to FIG. 1.

The method 100 as shown in FIG. 2 includes: receiving 110 identification information 61 from the terminal 60.

The method 100 includes: determination 120 of license plate information 76 based on the identification information 61.

The method 100 includes: outputting 130 license plate information 76 by means of an output device 76 of the license plate 70.

### REFERENCE SIGNS (PART OF THE DESCRIPTION)

50 Motor vehicle
51 Outer skin
52 Onboard electrical system
53 Motor vehicle control unit
54 Lock and/or unlock signal
55 User
60 Terminal
61 Identification information
62 Key
70 Electronic license plate
75 Output device
76 License plate information
80 Communication interface
90 Data processing device
95 Server
96 Reconciliation information
100 Method
110 Receiving
120 Determining
130 Outputting

1. An electronic license plate for a motor vehicle, wherein the motor vehicle has an active connection to a terminal of a user of the motor vehicle, wherein the electronic license plate comprising:
an output configured to provide license plate information;
a communication interface configured for wireless communication;
a data processing device configured to operate the license plate;
wherein
the communication interface is configured to receive identification information from the terminal; and
the data processing device is configured to determine the license plate information based at least in part on the identification information and to operate the output to output the license plate information.

2. The electronic license plate as claimed in claim 1, wherein the identification information includes a key assigned to the terminal or the user, and the data processing device is configured to match the key.

3. The electronic license plate as claimed in claim 2, wherein the communication interface is configured to communicate with an external server and to receive matching information, wherein the matching information is used by the data processing device to match the key.

4. An electronic license plate as claimed in claim 2, wherein the data processing device is configured to process identification information associated with a number of different terminals, a number of different users, or a number of different terminals and users.

5. The electronic license plate as claimed in claim 4, wherein the communication interface is configured to communicate with an external server and to receive matching information, wherein the matching information is used by the data processing device to match the key.

6. The electronic license plate as claimed in claim 5, wherein the communication interface is configured to communicate p with a motor vehicle control unit and to output at least one of the group consisting of a lock signal to lock a vehicle function and an unlock signal to unlock the vehicle function.

7. An electronic license plate as claimed in 1, wherein the data processing device is configured to process identification information associated with a number of different terminals, a number of different users, or a number of different terminals and users.

8. The electronic license plate as claimed in claim 1, wherein the communication interface is configured to communicate with an external server and to receive matching information.

9. The electronic license plate as claimed in claim 8, wherein the communication interface is configured to communicate with a motor vehicle control unit and to output at least one of the group consisting of a lock signal to lock a vehicle function and an unlock signal to unlock the vehicle function.

10. The electronic license plate as claimed in claim 1, wherein the communication interface is configured to communicate with a motor vehicle control unit and to output at least one of the group consisting of a lock signal to lock a vehicle function and an unlock signal to unlock the vehicle function.

11. A method for the operation of an electronic license plate for a motor vehicle, wherein the motor vehicle has an active connection to a terminal of a user of the motor vehicle, wherein the method includes:
receiving identification information from the terminal;
determining license plate information based at least in part on the identification information; and
causing output of the license plate information using an output of the electronic license plate.

12. The method as claimed in claim 11, wherein the identification information includes a key assigned to the terminal or the user, and wherein determining the license plate information includes matching the key to a key associated with the electronic license plate.

13. A non-transitory computer-readable medium, comprising instructions which, when executed by a data processing device, cause it to carry out the method as claimed in claim 11.

14. A motor vehicle containing the electronic license plate as claimed in claim 1.

15. The motor vehicle as claimed in claim 14, wherein the motor vehicle has an outer skin and an on-board electrical system, and the electronic license plate is integrated into the outer skin.

16. The motor vehicle as claimed in claim 15, wherein the electronic license plate can be operated by means of the on-board electrical system.

17. The motor vehicle as claimed in claim 14, wherein the motor vehicle has an on-board electrical system, and the electronic license plate can be operated by means of the on-board electrical system.
